(19) United States
(12) Patent Application Publication
(10) Pub. No.: US 2002/0089720 A1
(43) Pub. Date: Jul. 11, 2002

(54) Optical channelizer and router and routing method

(76) Inventors: Murray Steinberg, Palo Alto, CA (US); John Walker, Union City, CA (US)

Correspondence Address: Joyce Kosinski, Loral Space and Communications, Ltd., 655 Deep Valley Drive, Suite 385, Rolling Hills Estates, CA, 90274, US

(21) Appl. No.: 09/756,569

(22) Filed: Jan. 8, 2001

(51) Int. Cl. H04J 14/00; H04J 14/02

(52) U.S. Cl. 359/128; 359/117

(57) ABSTRACT

An optical channelizer and router and routing method that are preferably employed on a satellite. An exemplary optical channelizer and router and method comprises a laser that generates a coherent optical beam that is output to a beam fanout device that divides the beam to produce a plurality of coherent optical beams. A plurality of spatial light modulators process the plurality of coherent optical beams and a plurality of RF input signals, and each outputs a set of spatially separated output beams. A plurality of optical frequency translators translate the optical frequencies of each set of spatially separated output beams by a different predetermined amount to produce respective sets of frequency translated spatially separated output beams. An optical switch routes each set of frequency translated spatially separated output beams to a different output port determined by the signal frequency of the respective RF input signals and the settings of the optical switch. A plurality of optical mulitiplexers multiplex the sets of switched frequency translated spatially separated output beams to produce a plurality of multiplexed output beams. A charge coupled device array receives each of the multiplexed output beams and converts them into a plurality of electrical signals corresponding to the plurality of RF input signals.

### BACKGROUND

The present invention relates generally to satellite-based communication systems and methods, and more particularly, to improved optical channelizer and router and routing method for use on a satellite.

The current technique for routing of signals on a communications satellite is by means of a digital or analog electrical switch. Such switches are relatively complex and switching is done in the electrical domain.

It would be desirable to have a switching mechanism that improves upon the capabilities of conventional digital or analog electrical switches employed in satellite-based communications systems. It is therefore an objective of the present invention to provide for an optical channelizer and router and routing method that may be used on a satellite.

### SUMMARY OF THE INVENTION

To accomplish the above and other objectives, the present invention provides for an optical channelizer and router and routing method that are preferably employed on a satellite. The optical channelizer and router along with the routing method provides multibeam communication satellites with the capability of receiving uplink multiplexed RF signals in one beam and routing the signals to one or more downlink beams. The routing provided by the optical channelizer and router and routing method is programmable.

An exemplary optical channelizer and router comprises a laser for outputting a coherent optical beam and a beam fanout device that outputs a plurality of coherent optical beams. A plurality of spatial light modulators receives the plurality of coherent optical beams and a plurality of RF input signals. The spatial light modulators demultiplex the multiplexed RF signals and each outputs a set of spatially separated output beams. There is one output beam for each one of the RF signals that had been multiplexed together and each of the beams contains the information that had been present in the corresponding RF signal. A plurality of optical frequency translators translate the optical frequencies of each set of spatially separated output beams by a different predetermined amount to produce respective sets of frequency translated spatially separated output beams. An optical switch routes each set of frequency translated output beams to a different output port determined by the signal frequency of the respective RF input signals and the settings of the optical switch. A plurality of optical mulitiplexers multiplex the sets of switched frequency translated output beams to produce a plurality of multiplexed output beams. A charge coupled device array receives each of the multiplexed output beams and converts them into a plurality of electrical signals corresponding to the plurality of RF input signals.

An exemplary method for routing a set of M multiplexed RF input signals derived from an input beam to one or more output beams, comprising the following steps. A coherent optical beam is generated. The coherent optical beam is divided into a plurality of N coherent optical beams. Each of the plurality of coherent optical beams are spatially modulated using respective ones of the plurality of multiplexed RF input signals. This results in a plurality of sets of M spatially separated output beams. There are M) output beams from each spatial light modulator. Each on of the M beams contains the information that had been contained in the M multiplexed RF signals. The optical frequency of each set of spatially modulated output beams is frequency translated by a different predetermined amount to produce respective sets of frequency translated output beams. Each set of frequency translated output beams is routed to a different output port as a function of the signal frequency of the respective RF input signals. Each of the routed sets of frequency translated spatially modulated output beams is multiplexed to produce a plurality of output beams. The plurality of output beams are converted into a plurality of electrical signals corresponding to the plurality of RF input signals that comprise the one or more output beams.

One novel aspect of the present invention is that all demultiplexing, switching, and multiplexing functions are performed at optical frequencies onboard the satellite. The satellite optical channelizer and router also operates at lower power, occupies smaller volume, and has lower mass than the existing electrical routing systems and switches. In addition, the satellite optical channelizer and router provides an optimal solution for satellites employing optical crosslinks.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates the architecture of an exemplary satellite optical channelizer and router in accordance with the principles of the present invention; and

FIG. 2 is a flow diagram that illustrates an exemplary method for routing a plurality of multiplexed RF input signals derived from an input beam to one or more output beams.

### DETAILED DESCRIPTION

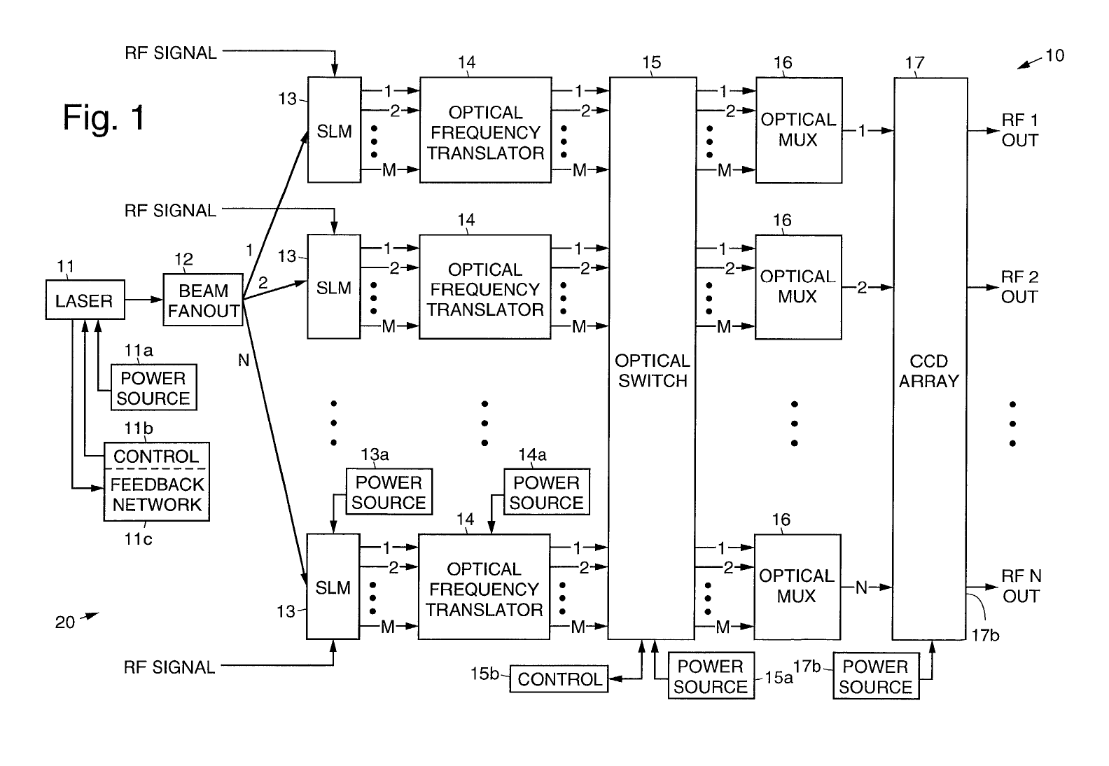

Referring to the drawing figures, FIG. 1 illustrates the architecture of an exemplary optical channelizer and router 10 in accordance with the principles of the present invention. The optical channelizer and router 10 is preferably employed on a satellite 20 (generally designated).

The optical channelizer and router 10 comprises a single solid state laser 11 including a power source 11a and a control circuit 11b. The laser 11 outputs a coherent optical (laser) beam. The control circuit 11b includes a stabilizing feedback network 11c that is designed to ensure the constancy of the wavelength of the laser output under changing external conditions such as temperature variations. The output of the solid state laser 11 is optically coupled by way of an optical fiber 18 to an input of a beam fanout device 12 having a plurality (N) of output ports.

The plurality (N) of output ports of the beam fanout device 12 are optically coupled by way of a plurality of optical fibers 18 to inputs of a plurality (N) of spatial light modulators (SLM) 13 (where N is equal to the number of uplink RF beams each containing up to M multiplexed RF signals). Each of the spatial light modulators 13 has a power source 13a (only one shown). Each of the spatial light modulators 13 has M outputs. An RF signal is input to each of the respective spatial light modulators 13.

The M outputs of each of the spatial light modulators 13 are optically coupled by way of a plurality of optical fibers 18 to a plurality (N) of optical frequency translators 14. Each of the optical frequency translators 14 has a power source 14a (only one shown).

The M outputs of each of the optical frequency translators 14 are optically coupled by way of a plurality of optical fibers 18 to N sets of M inputs of an optical switch 15. The optical switch 15 has N sets of M optical outputs. The optical switch 15 includes a power source 15a and a control circuit 15b. The control circuit 15b allows changing of the state of the optical switch 15 as required. By way of example, the state of the optical switch 15 is changed when the users of the system request a change in routing of the signals they are sending.

The N sets of M outputs of the optical switch 15 are optically coupled by way of a plurality of optical fibers 18 to a plurality (N) of optical mulitiplexers (MUX) 16. Each of the optical mulitiplexers 16 has a single output.

The multiplexed outputs of each of the optical mulitiplexers 16 are optically coupled by way of a plurality of optical fibers 18 to a charge coupled device (CCD) array 17 comprising a plurality (N) of charge coupled devices. The CCD array 17 includes a power source 17a and output circuitry 17b.

In operation, the laser 11 outputs a coherent light beam that the beam fanout device 12 divides into N light beams and delivers to each of the spatial light modulators 13. The RF signal is input to each of the spatial light modulators 13 where it diffracts the laser light beams. The output of each spatial light modulator 13 comprises M light beams separated in space and having differing frequencies and varying intensities (where M is the number of RF signals that are to be multiplexed together in a given output beam). The frequencies and variations in intensity are functions of the frequencies and modulation of the RF signals input to the spatial light modulators 13.

The M light beams from each spatial light modulator 13 are separately coupled via the optical fibers 18 to separate frequency translators 14. There are M ports on each of the translators 14. Each set of M beams (each originating from a separate beam) is translated by a different predetermined amount. The amount of translation is determined by the number of RF signals in each beam and the number of signals to be multiplexed onto each down link beam.

The outputs of the frequency translators 14 are then coupled to the optical switch 15. The optical switch 15 routes each signal to a different output port. The output port to which each signal is routed is determined by the input port and by the setting of the optical switch 15. The input ports are determined by the frequencies of the respective RF input signals. The routing is controlled by the uplink signal frequency and the settings of the optical switch 15. The optical switch 15 comprises M×N input ports and M×N output ports.

The output ports of the optical switch 15 are in N groups, each group containing M ports. There is an optical multiplexer 16 corresponding to each member of the N groups. The M signals from each of the N groups are frequency multiplexed by the corresponding optical multiplexer 16 into a single light beam. The N multiplexed signals are then coupled to the CCD array 17. Each multiplexed signal is converted by a single element of the CCD array 17 into an electrical signal.

The laser control circuit 11b insures the stability of the laser 11. The switch control circuit 15b is commandable from a ground station (not shown), as well as from computers onboard the satellite 20, and sets the configuration of the optical switch 15.

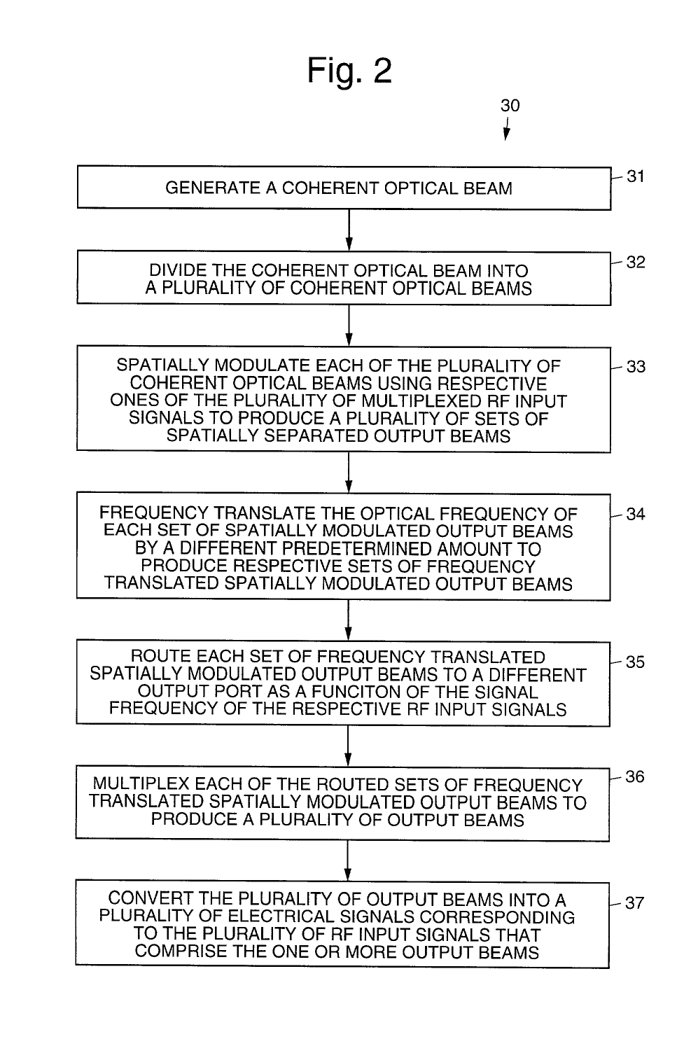

Referring to FIG. 2, it is a flow diagram that illustrates an exemplary method 30 for routing a plurality of multiplexed RF input signals derived from an input beam to one or more output beams. The exemplary method 30 comprises the following steps, A coherent optical beam is generated 31. The coherent optical beam is divided 32 into a plurality of coherent optical beams. Each of the plurality of coherent optical beams are spatially modulated 33 using respective ones of the plurality of multiplexed RF input signals to produce a plurality of sets of M) of spatially separated output beams thus demultiplexing the input RF signals. The optical frequency of each set of spatially separated output beams is frequency translated 34 by a different predetermined amount to produce respective sets of frequency translated spatially separated output beams. Each set of frequency translated spatially separated output beams is routed 35 to a different output port as a function of the signal frequency of the respective RF input signals. Each of the routed sets of frequency translated spatially separated output beams is multiplexed 36 to produce a plurality of output beams. The plurality of output beams are converted 37 into a plurality of electrical signals corresponding to the plurality of RF input signals that comprise the one or more output beams.

Thus an optical channelizer and router and routing method that may be used on a satellite has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. An optical channelizer and router comprising:
a laser for outputting a coherent optical beam;
a beam fanout device having an input port for receiving the coherent optical beam and a plurality of output ports for outputting a plurality of coherent optical beams;
a plurality of spatial light modulators for respectively receiving the plurality of coherent optical beams and a plurality of RF input signals, each of the modulators outputting a set of spatially separated output beams;
a plurality of optical frequency translators for respectively receiving the sets of spatially separated output beams and for translating the optical frequency of each set of spatially separated output beams by a different predetermined amount to produce respective sets of frequency translated spatially separated output beams;
an optical switch for receiving each of the sets of frequency translated spatially separated output beams and for routing each set of frequency translated spatially separated output beams to a different output port, wherein the output port to which each beam is routed is determined by the signal frequency of the respective RF input signals and the settings of the optical switch;
a plurality of optical mulitiplexers for receiving the respective sets of switched frequency translated spatially modulated output beams, and for multiplexing the sets of beams to produce a plurality of multiplexed output beams; and
a charge coupled device array coupled to receive each of the multiplexed output beams for outputting a plurality of electrical signals corresponding to the plurality of RF input signals.

2. The system recited in claim 1 wherein the laser comprises a power source and a control circuit.

3. The system recited in claim 2 wherein the control circuit comprises a stabilizing feedback network.

4. The system recited in claim 1 wherein the plurality of spatial light modulators each comprise a power source.

5. The system recited in claim 1 wherein the plurality of optical frequency translators each comprise a power source.

6. The system recited in claim 1 wherein the optical switch comprises a power source and a control circuit.

7. The system recited in claim 1 wherein the charge coupled device array 17 comprises a power source.

8. The system recited in claim 1 wherein the laser comprises a solid state laser.

9. The system recited in claim 1 wherein the laser, beam fanout device, plurality of spatial light modulators, plurality of optical frequency translators, optical switch, plurality of optical mulitiplexers, and charge coupled device array are optically coupled together by way of optical fibers.

10. A method for routing a plurality of multiplexed RF input signals derived from an input beam to one or more output beams, comprising the steps of:
generating a coherent optical beam;
dividing the coherent optical beam into a plurality of coherent optical beams;
spatially modulating each of the plurality of coherent optical beams using respective ones of the plurality of multiplexed RF input signals to produce a plurality of sets of spatially separated output beams;
frequency translating the optical frequency of each set of spatially separated output beams by a different predetermined amount to produce respective sets of frequency translated spatially separated output beams;
routing each set of frequency translated spatially modulated output beams to a different output port as a function of the signal frequency of the respective RF input signals;
multiplexing each of the routed sets of frequency translated spatially modulated output beams to produce a plurality of output beams; and
converting the plurality of output beams into a plurality of electrical signals corresponding to the plurality of RF input signals that comprise the one or more output beams.
